(19) United States
(12) Patent Application Publication
(10) Pub. No.: US 2020/0290173 A1
(43) Pub. Date: Sep. 17, 2020

(54) ALUMINUM TANK POLISHING SYSTEM AND METHOD OF USE

(71) Applicant: John A. Hart, Justin, TX (US)

(72) Inventor: John A. Hart, Justin, TX (US)

(21) Appl. No.: 16/817,536

(22) Filed: Mar. 12, 2020

Related U.S. Application Data
(60) Provisional application No. 62/817,031, filed on Mar. 12, 2019.

(51) Int. Cl. B24B 41/00; B24B 29/08; B24B 29/04; B24B 41/06; B25J 15/06

(52) U.S. Cl. CPC B24B 41/005; B24B 29/08; B24B 41/04; B24B 41/062; B25J 15/0616; B24B 29/04

(57) ABSTRACT

A tank polishing system for polishing a tank, the system includes a polishing cell housing a body polishing station and an end polishing station; an input window leading into the polishing cell; an output window leading out of the polishing cell; a robot having an arm with one or more vacuum cups to releasably secure to the tank via vacuum pressure, the robot housed within the polishing cell and to transfer the tank from the input window, to the body polishing station, to the end polishing station, and to the output window; a body polishing machine to polish the tank at the body polishing station; and a control system to receive user commands to operate the robot and the one or more polishing machine.

### BACKGROUND

### 1. Field of the Invention

The present invention relates generally to tank polishing systems and methods, and more specifically to a tank polishing system that utilizes a robot and vacuum suction to automate the transfer of a tank between polishing stations, thereby providing for an efficient means to polish a plurality of tanks quickly and effectively.

### 2. Description of Related Art

Tank polishing systems are well known in the art and are effective means to clean and shine a tank, such as an aluminum tank, thereby providing for aesthetic appeal. For example, FIG. 1 depicts a flowchart 101 of a conventional tank polishing method, wherein the operator either starts with a natural tank or an aluminum tank becomes oxidized during use, thereby losing shine, as shown with box 103. The operator will either leave the tank secured to a vehicle, or alternatively, remove the tank and mount the tank to a frame structure, as shown with box 105. The user will then proceed to use a grinder to smooth and polish the aluminum tank, as shown with box 107. As desired, the user may add a liquid polish to clean residue and add shine, as shown with box 109.

One of the problems commonly associated with method 101 is inefficiency. For example, this process is manual, labor intensive, and time consuming. Accordingly, it would be desirable to provide a system that automates a large portion of the polishing procedure.

Accordingly, although great strides have been made in the area of tank polishing systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common tank polishing method;

FIG. 2 is a simplified schematic of a tank polishing system in accordance with a preferred embodiment of the present application;

FIG. 3 is a flowchart of the steps associated with the system of FIG. 1;

FIG. 4 is a simplified side view of the robot of FIG. 2;

FIGS. 5A and 5B are side view of an embodiment of the body polishing station of FIG. 2;

FIG. 6 is a flowchart of the method associated with the body polishing station of FIGS. 5A and 5B;

FIGS. 7A and 7B are end view of an embodiment of an end polishing station of FIG. 2;

FIG. 8 is a flowchart of the method associated with the end polishing station of FIGS. 7A and 7B; and

FIG. 9 is a schematic of the electrical components and control system components as part of the system of FIG. 2 in accordance with the present application.

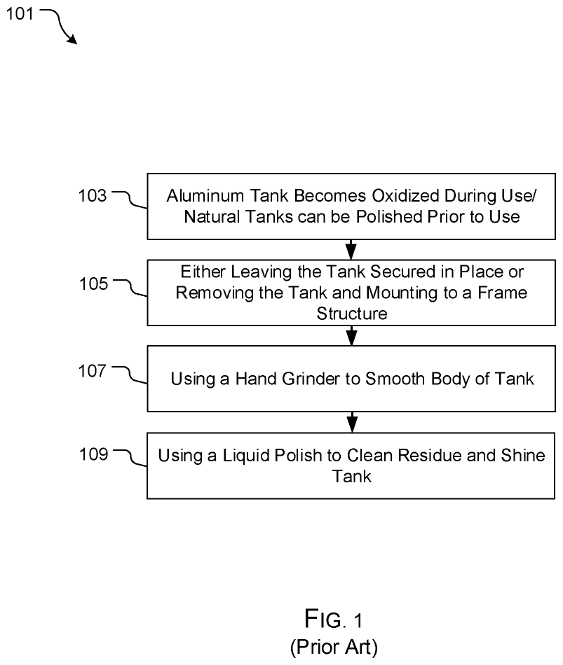

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional polishing systems. Specifically, the present invention provides for a nearly automated system wherein a robot is utilized to transfer tanks from one station to a next until the tank is fully polished. In addition, the system utilizes vacuum sealed attachments to the tank, thereby providing for an easy and efficient attachment and release mechanism. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

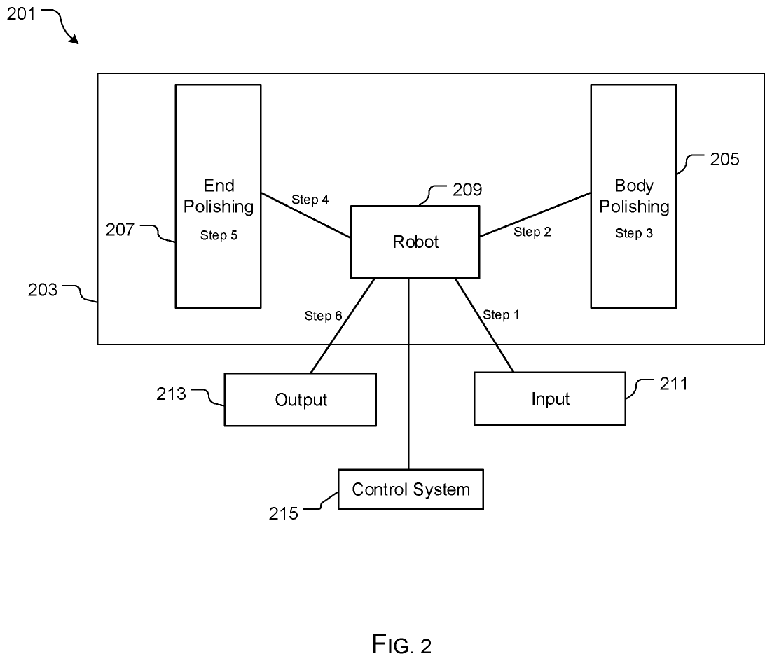

Referring now to the drawings wherein like reference characters identify corresponding or similar elements throughout the several views, FIG. 2 depicts a schematic view of a tank polishing system 201 in accordance with a preferred embodiment of the present application. It will be appreciated that system 201 overcomes one or more of the above-listed problems commonly associated with conventional tank polishing methods systems.

It should be appreciated that although the preferred embodiment discussed herein is suitable for aluminum tanks having a diameter between 20 and 30 inches, the system can easily be adapted for other tanks of differing sizes and provide the same benefit.

In the contemplated embodiment, system 201 includes a polishing cell 203 wherein a body polishing station 205 and end polishing station 207 are located. In addition, a robot 209 is positioned within the cell 203 and is configured to provide transferring movement of a plurality of tanks. The system includes an input window 211 leading into the cell 203 and an output window 213 leading out of the cell. Further included is a control system 215, wherein the user can provide commands regarding the use of system 201.

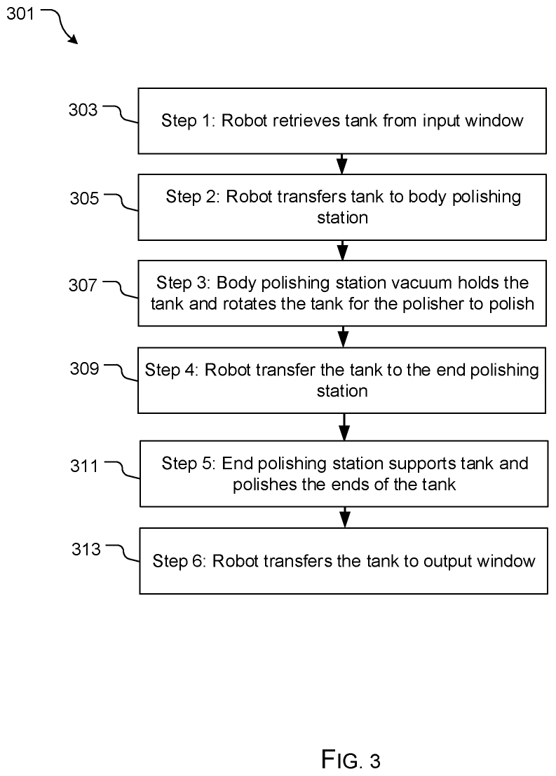

In FIG. 3, a flowchart 301 depicts the simplified steps of use associated with system 201. During use, the robot first retrieves a tank from the input window and, after the control system determines that the body polishing station is free, transfers the tank to the body polishing station wherein the body portion of the tank will be polished, as shown with boxes 303, 305, 307. Upon completion in the body polishing station, the robot retrieves the tank and transfers the tank to the end polishing station, as shown with box 309. The end polishing station will support the tank and provide end polishing functions, as shown with box 311. Upon completion, the robot will again retrieve the tank and transfer the tank to the output window, as shown with box 313. It should be appreciated that the stations can be continuously working, such that once the robot moves one tank from the body polishing station to the end polishing station, the robot can move a second tank from the input window to the body polishing station.

It should be appreciated that one of the unique features believed characteristic of the present application is the stations, in combination with a robot and the utilization of vacuum seals, that provides an efficient means to polish a plurality of tanks quickly.

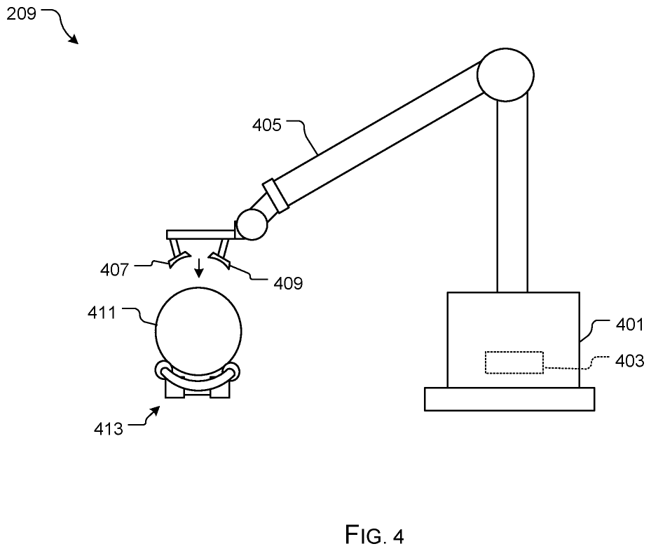

FIG. 4 depicts a simplified side view of a robot 209 for use with system 201. It should be appreciated that the robot can vary so long as the functionality is supported. The robot 209 can include a base 401 to be positioned in a central location, the base 401 further housing any necessary electrical and computing components 403, thereby providing a means to receive and process commands and operations. The robot 209 including an arm 405 that has one or more vacuum cups 407, 409 configured to engage with a tank 411, thereby providing a means to lift and carry the tank from location to location. In the preferred embodiment, the tank 411 will start out supported by a support structure 413 in the input window, wherein the support structure can vary but provides for the necessary features to support the tank in a stationary position.

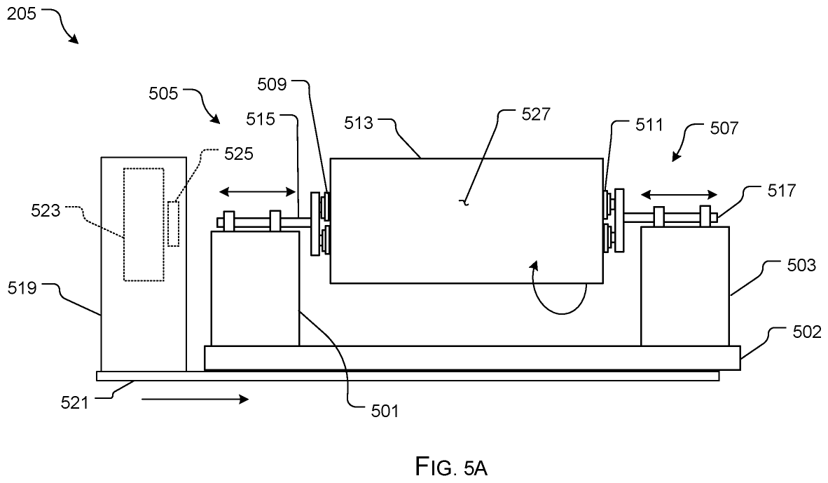

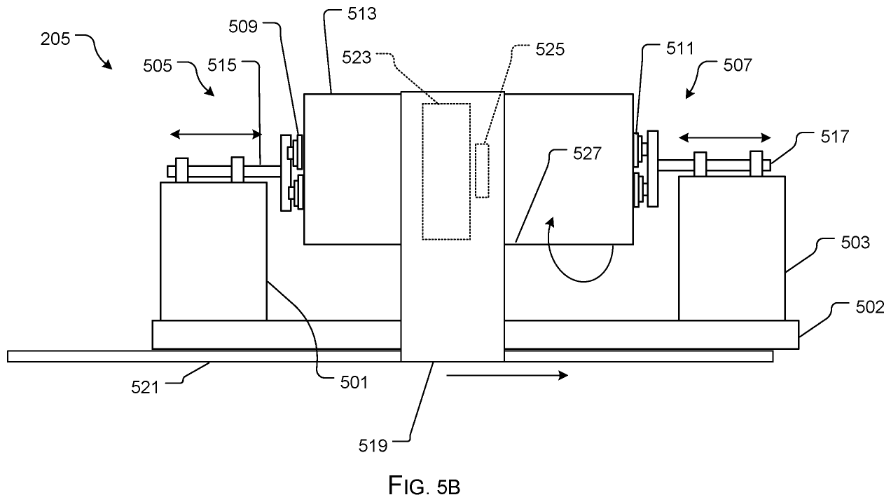

In FIGS. 5A and 5B, simplified side views of the body polishing station 205 are shown. The body polishing station 205 includes a tail stock 501 and a head stock 503, each having a vacuum mount 505, 507 with one or more vacuum cups 509, 511 to receive and support the tank 513. In the preferred embodiment, the vacuum mounts include shafts 515, 517 configured to provide rotating movement of the tank during operation. As will be discussed, the stocks 501, 503 are configured to move forward and backward via a support 502, thereby allowing for engagement with different sized tanks.

The body polishing station 205 further includes a body polishing machine 519 that is engaged with a track 521 and is configured to traverse thereon. The body polishing machine 519 can include features known in the art, such as a polishing wheel 523 and a spray component 525. As shown in FIG. 5B, the body polishing machine will move along a side surface 527 of the tank and providing polishing operations.

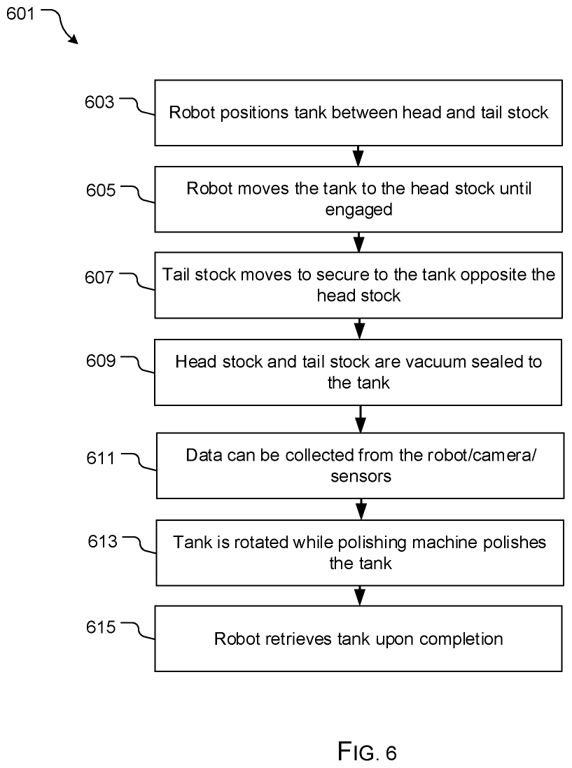

In FIG. 6, a flowchart 601 depicts a method associated with the body polishing station of FIGS. 5A and 5B. During use, the robot will first determine that the body polishing station is available and that the tail stock and head stock are in their home position, and then will proceed to position retrieve the tank from the input window and position the tank between the tail and head stock, as shown with box 603. The robot will move the tank toward the head stock until a sensor signifies that the tank has engaged with the vacuum cups of the head stock, as shown with box 605. The tail stock will then move toward the tank until the sensor signifies that the vacuum cups have engaged the tank, as shown with box 607. Data can be collected, and the vacuum is turned on such that the tank is secured in place via vacuum pressure, as shown with box 611. The tank is then rotated while the polishing machine polishes the body sides of the tank, as shown with box 613. Upon completion, the robot will retrieve the tank and move the tank on to the next station, as shown with box 615.

It should be appreciated that the system is configured to rotate the tank at a proper speed while the polishing machine moves down the tank at the proper speed. Constant pressure is applied by the polish wheel to the tank, and a polish spray can be applied in a proper amount to ensure efficient polishing of the tank.

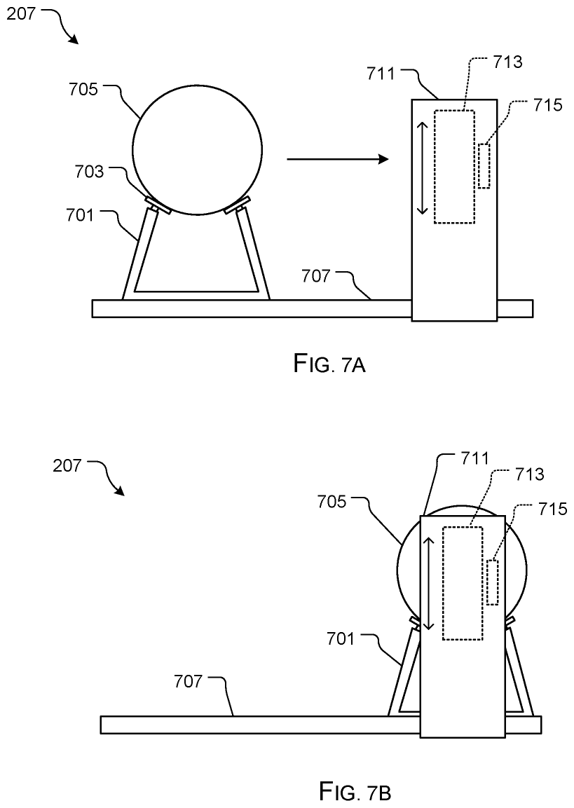

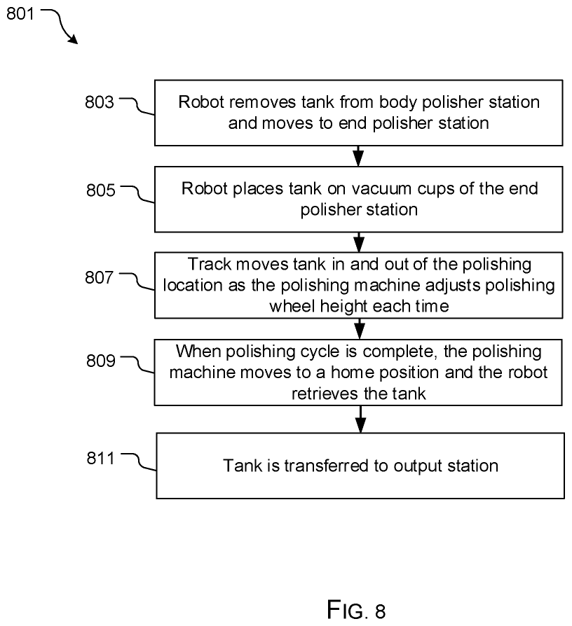

In FIGS. 7A and 7B, simplified end views of the end polishing station 207 are shown. The end polishing station 207 includes a support 701 having one or more vacuum cups 703 configured to receive and support the tank 705 on a track 707, the support 701 configured to traverse relative to the track 707 to position the tank 705 such that an end 709 will receive polishing from a polishing machine 711. It should be appreciated that the polishing machine 711 can include known features in the art, including a polishing wheel 713 and a spray apparatus 715, thereby providing an effective polishing means. It should be appreciated that the polishing machine can be configured to raise and lower the polishing wheel 713 based on commands received from the control system to effectively reach all areas of the end of the tank.

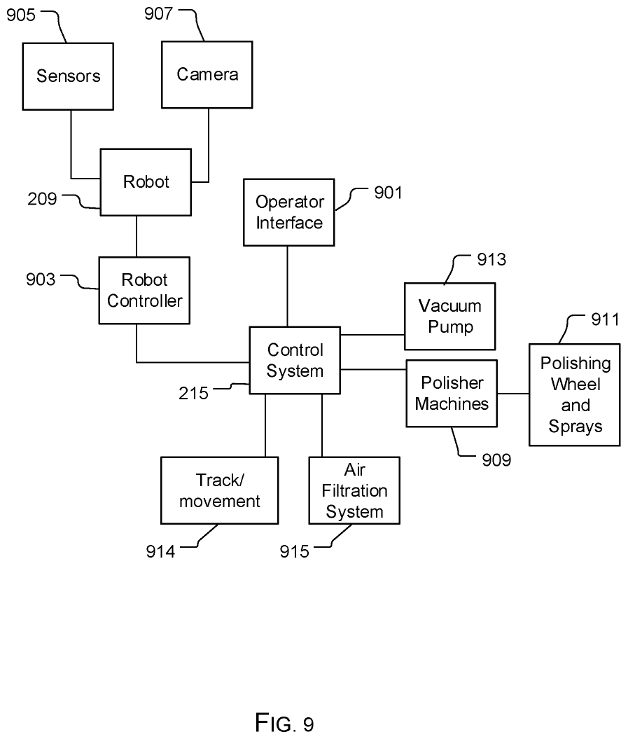

In FIG. 8, a flowchart 801 depicts the method associated with end polishing station 207. During use, the control system and robot will determine if the end polishing station 207 is available and if so, the robot will retrieve the tank from the body polishing station and transfer the tank to the support 701 of the end polishing station, as shown with boxes 803, 805. The tank will be moved in and out of the polishing location in front of the polishing machine and the polishing machine adjusts the wheel height each time, thereby ensuring full coverage of polishing, as shown with box 807. When the cycle is complete, the polishing machine moves to the home position and the robot retrieves the tank and transfers the tank to the output window, wherein the operator can then retrieve the tank, as shown with boxes 809, 811.

In FIG. 9, a simplified schematic depicts additional features associated with the tank polishing system. The control system 215 can include an operator interface 901, wherein the operator can input commands and the like. The control system 215 is configured to work with all of the components, wherein pre-programmed commands and/or user inputted commands can be used to automate or near-automate the polishing of a plurality of tanks. The control system 215 is in communication with the robot 209 through one or more robot controllers 903. The robot 209 can include one or more sensors 905 and/or cameras 907. It should be appreciated that the sensors can be used to determine when a vacuum seal associated with any of the vacuum components is sealed and secure. The cameras 907 can be configured to collect data and determine features of the tank, such as a filler neck location, a multi-boss location, and other odd fittings, as well as the dimensions of the tank. It should be appreciated that the control system 215 is further in communication with the polisher machines 909 to operate the polishing wheels and spray components 911 as needed. The control system 215 further is in communication with one or more vacuum pumps 913 that provides a means to create the plurality of vacuum seals. The control system 215 can be in further communication with the various tracks 914 for creating movement of the necessary components. In some embodiments, an air filtration system 915 can be utilized to filter air within the polishing cell. It should be appreciated and understood that other necessary components, such as wires and the like, are utilized to make connections as needed.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A tank polishing system for polishing a tank, the system comprising:
a polishing cell housing a body polishing station and an end polishing station;
an input window leading into the polishing cell;
an output window leading out of the polishing cell;
a robot having an arm with one or more vacuum cups configured to releasably secure to the tank via vacuum pressure, the robot housed within the polishing cell and configured to transfer the tank from the input window, to the body polishing station, to the end polishing station, and to the output window;
a body polishing machine configured to polish the tank at the body polishing station; and
a control system configured to receive user commands to operate the robot and the one or more polishing machine.

2. The system of claim 1, further comprising:
a support positioned in the input window and configured to hold the tank prior to transport via the robot.

3. The system of claim 1, wherein the body polishing station comprises:
a tail stock having a first vacuum mount attached to a first axis and configured to secure to a first end of the tank;
a head stock having a second vacuum mount attached to a second axis and configured to secure to a second end of the tank;
the body polishing machine being engaged with a track and configured to traverse past a side of the tank, the body polishing machine having:
a polishing wheel configured to engage with the side of the tank as the body polishing machine traverses past the tank; and
a spray component configured to spray the side of the tank as the polishing machine traverses past the tank;
wherein the head stock and tail stock are configured to rotate the tank via the first and second vacuum mounts during polishing.

4. The system of claim 1, wherein the end polishing station comprises:
a tank support having one or more vacuum cups configured to releasable seal with a surface of the tank;
a track configured to support the tank support and provide for traversing movement of the tank support; and
an end polishing machine having a polishing wheel positioned to engage with an end of the tank as the tank traverses past the end polishing machine.

5. The system of claim 1, further comprising:
a camera engaged with the robot and configured to communicate with the control system, the camera configured to determine a size of the tank.

6. The system of claim 1, further comprising:
one or more sensors configured to determine a vacuum seal associated with the tank.

7. The system of claim 1, wherein the control system further includes:
an operator interface configured to receive input from an operator.

8. The system of claim 1, wherein the control system is in communication with a vacuum pump configured to create one or more vacuum seals associated with the tank.

9. The system of claim 1, further comprising:
an air filtration system in communication with the control system and configured to provide air filtering of the polishing cell housing.
